(19) United States
(12) Patent Application Publication
(10) Pub. No.: US 2023/0288914 A1
(43) Pub. Date: Sep. 14, 2023

(54) FEATURE DRIVEN NEXT VIEW PLANNING OF 3-DIMENSIONAL SURFACES

(71) Applicant: Worcester Polytechnic Institute, Worcester, MA (US)

(72) Inventors: James Akl, Worcester, MA (US); Fadi Alladkani, Worcester, MA (US); Berk Calli, Worcester, MA (US); Roger Morton, Warrington (GB)

(21) Appl. No.: 18/119,547

(22) Filed: Mar. 9, 2023

Related U.S. Application Data
(60) Provisional application No. 63/318,135, filed on Mar. 9, 2022.

(51) Int. Cl. G05B 19/4103; G06T 7/11; G06V 10/26

(52) U.S. Cl. CPC G05B 19/4103; G06T 7/11; G06V 10/26; G06T 2207/10028

(57) ABSTRACT

A robotic cutting device includes a cutting tool responsive to a mobile actuator adapted to apply a cutting force in a 3-dimensional (3D) space, and scanning logic configured to identify a cutting path denoted on an article for cutting. Using the cutting path, a mobile actuator is responsive to positioning logic for disposing the cutting tool along the cutting path for performing a prescribed cut on the article. The mobile actuator is a robotic arm responsive to an independent coordinate frame based on a position and orientation of a mobility vehicle supporting the mobile actuator. Cutting is based on traversal of a prescribed path formed from marking or painting optically distinct features. Pixel based analysis reconstructs the path for cutting using a probabilistic evaluation of only the cutting region based on a prediction of path progression, and avoids exhaustive mapping, analysis or reconstruction of the entire article.

### RELATED APPLICATIONS

This patent application claims the benefit under 35 U.S.C. § 119(e) of U.S. Provisional Patent App. No. 63/318,135, filed Mar. 9, 2022, entitled “FEATURE DRIVEN NEXT VIEW PLANNING OF 3-DIMENSIONAL SURFACES,” incorporated herein by reference in entirety.

### BACKGROUND

Salvaging and recycling large, decommissioned metal structures such as oil rigs, ships, equipment (e.g. large engines) generally requires them to be dismantled, moved to a metal scrap yard and cut into small workable segments or chunks. Dismantling and recycling the structures to reclaim the raw materials often requires manual cutting operations. Depending on the skill of the workers and available tools such as gas torches, the work is generally slow, labor intensive and often dangerous.

### SUMMARY

A robotic cutting device includes a cutting tool responsive to a mobile actuator adapted to apply a cutting force in a 3-dimensional (3-D) space, and scanning logic configured to identify a cutting path denoted on an article for cutting. Using the cutting path, a mobile actuator is responsive to positioning logic for disposing the cutting tool along the cutting path for performing a prescribed cut on the article. The mobile actuator is a robotic arm responsive to an independent coordinate frame based on a position and orientation of a mobility vehicle supporting the mobile actuator. Cutting is based on traversal of a prescribed path formed from marking or painting optically distinct features on the object or article. Pixel based analysis reconstructs the path for cutting using a probabilistic evaluation of only the cutting region based on a prediction of path progression, and avoids exhaustive mapping, analysis or reconstruction of the entire article.

In a more general sense, visualization and imaging of an object for performing robotic tasks requires substantial time and computing resources to complete. Mapping of an entire object to obtain a voxel representation requires exhaustive scanning of the object surface and storage of the voxel representation. In contrast, configurations herein traverse a feature or drawing, such as a painted line, and reconstruct only enough of the object surface to depict the drawing. The drawing is distinguished through feature recognition of a visually differentiated color, and a voxel representation of the drawing retained. In the example configuration, the drawing representation is used for robotic guidance of a cutting apparatus, however other suitable tasks may be addressed by similar performance improvements.

The cutting device or apparatus is responsive to control logic for performing a method of directing a cutting head along a scrap item or similar article, including traversing a prescribed path based on non-exhaustive analysis of a local area of features along the prescribed path, and evaluating a successive cutting position based on a likelihood of a direction that the prescribed path proceeds in. An optical feature recognition approach identifies the prescribed path based on an optical surface characteristic, and the prescribed path defines a cutting operation directed to a target object. The optical recognition allows the prescribed path to be specified by contrasting optical features and recognition of these optical features. The optical features are defined by a surface applied pigmentation, such as a line of paint having a recognized, contrasting color. Other mediums, such as magnetic and infrared, may also be incorporated.

Configurations herein are based, in part, on the observation that scrap cutting operations are often performed on modestly supported articles that may dislodge merely from the performed cutting. Unfortunately, conventional approaches to automating this dangerous task suffer from the shortcoming that substantial computational resources are required to adequately map and define an automated cutting pattern on an irregular object. Conventional approaches to imaging and mapping tend to scan and reconstruct an entire object. Exhaustive search and analysis is required over the entire article, even though the intended cutting path occupies only a small portion of the entire object or item. Accordingly, configurations herein substantially overcome the shortcomings of manual salvage cutting be providing a probabilistic, non-exhaustive search that analyzes only portions of the cut object based on a likelihood of progression along the cutting path. Optical features are gathered only in the region being approached by the cutting, and information gathered to identify a likely direction taken by the path, with more probable directions examined first. In this manner, analysis, mapping and reconstruction of the cutting line occurs from information gathered only in the region of the cutting line, agnostic to other, unaffected regions of the cut article or object.

Evaluating the object and prescribed path includes generating a probabilistic occupancy grid indicative of a search space in only the local area around the current cutting location. The analysis scores each cell in the grid based on a probability of path progression as to successive locations along the prescribed path. Generating the probabilistic occupancy grid may further includes gathering a sampling of surface features and corresponding cutting patterns as a baseline for probability, where the cutting position is evaluated based on the surface features and the likelihood of the direction computed based on the cutting patterns. Analysis continues by iteratively traversing the prescribed path based on a probabilistic determination of cells defining a search space including the prescribed path. Cutting for separation or excising the object defined by the prescribed path then follows the generated coordinates in the pixelated region around the prescribed path.

Forming the prescribed path may be performed in several suitable ways, such as marking or painting a line on the scrap item having varied optical features. A robotic cutting apparatus scans the features based on an optical recognition to define a 3-dimensional (3-D) recognition of the prescribed path as described above, and a robotic cutting apparatus is deployed for directing a cutting apparatus based on the 3-D recognition.

A corresponding method for cutting and excising the scrap object includes directing a cutting head along a scrap item by traversing a prescribed path based on non-exhaustive analysis of a local area of features along the prescribed path, and evaluating a successive cutting position based on a likelihood of a direction that the prescribed path proceeds in. A planner application iteratively traverses the prescribed path based on a probabilistic determination of cells defining a search space including the prescribed path.

### BRIEF DESCRIPTION OF THE DRAWINGS

The foregoing and other objects, features and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a context diagram of a robotic cutting environment suitable for use with configurations herein;

FIG. 2 shows a context of cutting path execution in the environment of FIG. 1;

FIG. 3A shows an example of cutting path exploration and execution through feature recognition of a drawing depicted by a painted line;

FIG. 3B shows a flowchart of point cloud gathering of features in response to a visual pattern imaged from a 3-dimensional (3-D) object as in FIG. 3A;

FIGS. 4A-4C show alternate approaches to drawing reconstruction through next best view approaches described herein;

FIG. 5 shows examples of the drawing on differing surface categories of mapped 3-D objects;

FIG. 6 shows camera orientation for directing a pose for a successive viewpoint in drawing reconstruction;

FIG. 7 shows occupancy probability in computing a next best view for following features of the drawing;

FIG. 8 shows frontier cells of the accumulated mapping as in FIG. 7; and

FIG. 9 shows occupancy probability of intermediate cells as representing part of the feature drawing.

### DETAILED DESCRIPTION

Example configurations below depict a human-robot collaboration scheme that combines the respective strengths of robots and skilled workers, in particular in an example useful with salvage and scrap operations and recovery of recyclable raw materials. The example configuration is particularly useful in salvage of large ocean-going vessels, which are typically dismantled in large, irregular sections or object of raw metal. In brief, a skilled worker inspects the target piece to determine an adequate cut. They then draw the cutting path on the object surface using an adequate marker, e.g., spray paint. Next, the vision-equipped robot examines the target object to locate the drawn path. The robot explores the drawing along the object to fully reconstruct it. With the acquired path and object properties, cutting trajectories are generated and the robotic cutting apparatus (robot) executes the cut.

A particularly important task involves exploring the target object's surface and extracting the 3-D drawing to generate a desired cutting path, based on the visual contrasting features defined by the painted drawing laid down by the worker. It is important to note that the objects and drawings are both unknown to the robot prior to the operation, as they would be in scrapyards. Moreover, the objects in scrapyards are often large and complex in shape, which requires a systematic exploration of the objects' surface; the drawings would not be visible from a single viewpoint of the camera and are often times self-occluded. Therefore, the robot needs to scan the drawing one image at a time and reconstruct it piece by piece on a surface whose size and shape are both unknown. For this, the robot must carefully and intelligently plan its camera's next poses (viewpoints). This goal employs next view planning (NVP), i.e., determining the camera's subsequent poses to fully explore the object's targeted feature. This paper builds on and enhances efforts detailed in prior patent, U.S. application Ser. No. 17/721,553, filed Apr. 15, 2022, entitled “SALVAGE METAL CUTTING ROBOT,” incorporated herein by reference in entirety, which outlines human-robot collaboration scheme. Configurations herein present a feature-driven active vision strategy to autonomously search for and reconstruct a drawn cutting reference on an object's surface, both having unknown size and shape. The NVP approaches herein efficiently constrain and guide the search using feature information to select the camera's next viewpoint. Configurations herein are not limited to scrap cutting but can also be applied to other problems that require 3-D feature reconstruction.

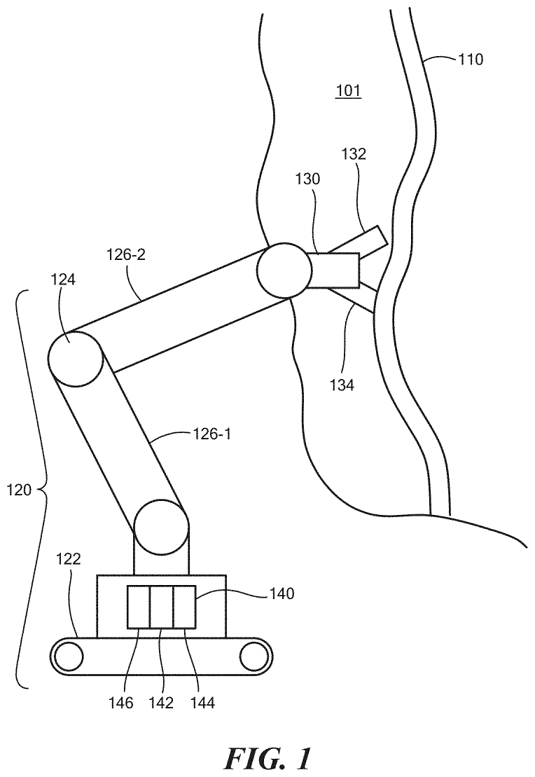

FIG. 1 is a context diagram of a robotic cutting environment suitable for use with configurations herein. Referring to FIG. 1, a mobile actuator 120 includes a drive 122 such as a set of tracks and a robotic arm 124 including one or more robotic members 126-1 . . . 126-2 (126 generally) for approaching the object 101 defining a salvage article and applied drawing 110 defining a proposed cutting path. An end effector 130 attaches to an end of the robotic arm 124 and includes an optical sensor 132 and a cutting tool 134. The optical sensor 132 is adapted to detect the cutting path based on a contrast of the drawing 110 with a surface of the object 101. The cutting tool 134 is a torch or blade adapted to sever the material composing the salvage article.

Positioning logic 140 in the mobile actuator 120 includes an image processor 142 for receiving and analyzing visual frames of the drawing 110, line fitting and reconstruction logic 144 including a planner for computing coordinate points defining the drawing, and a coordinate guidance processor 146 including a reconstructor for directing robotic movements of the robotic arm 124 in response to the computed coordinate points.

In operation, the mobile actuator 120 traverses the cutting path with the optical sensor 132 via optical recognition of the drawing 110 on the surface for generating a set of points defining the cutting path, where the cutting path traverses a plurality of planes along the irregular, often jagged, profile of the salvage article object 101. It then passes the cutting tool 134 along a curve defined by the set of points, where the cutting tool 134 is responsive to the actuator 130 driven based on the curve.

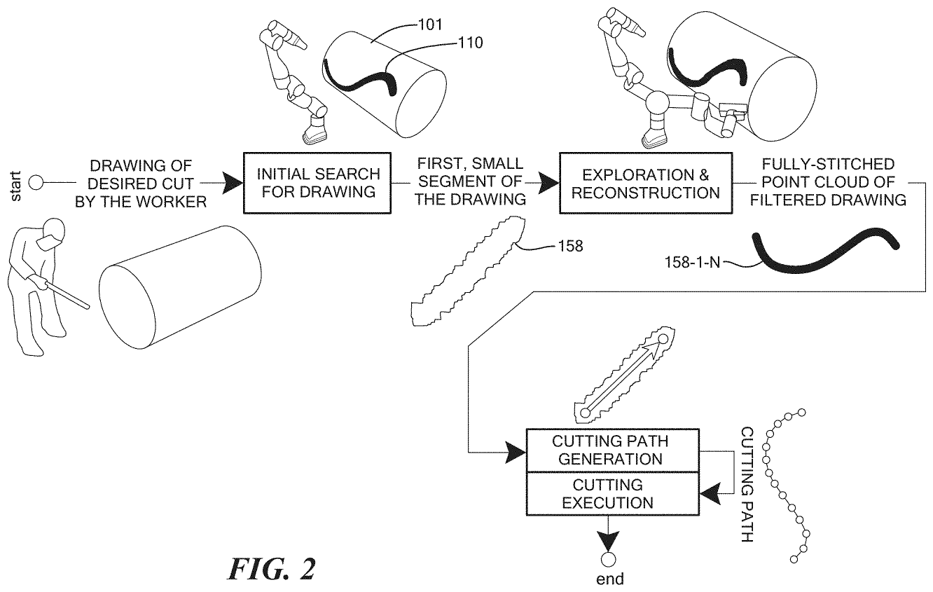

FIG. 2 shows an example of cutting path exploration and execution through feature recognition of a drawing 110 depicted by a painted line. Referring to FIGS. 1 and 2, the exploration and reconstruction task facilitates the eventual generation of a cutting path on an object 101. Instrumentally, it must provide an appropriate reconstruction of the desired feature (here, a 3-D colored drawing). This reconstructed drawing must cover as much of the original drawing as possible. Thus, the task's desired output is a high-coverage point cloud reconstruction of the drawing. Due to the high variance of object sizes and shapes, the robot's initial view is unlikely to contain the entire drawing. Accordingly, the robot keeps exploring the object until it fully uncovers the desired feature. Thus, the exploration and reconstruction routine is formulated as a loop that terminates once the drawing is considered fully explored. Until this stop condition is met, the robot repeats the following steps:
1) Acquire a colored point cloud image.
2) Transform the acquired cloud to the fixed base frame.
3) Combine clouds from several views to reconstruct a surface containing parts of the drawing.
4) Segment 158 the drawing region from the reconstruction.
5) Plan the next viewpoint using the extracted points.
6) Move to the next view while avoiding collisions.

In essence, we iteratively reconstruct a subset of the object's surface that contains the entire drawing, and then at each step, we use its available portion of the drawing to inform the next viewpoint. The search terminates once this reconstruction is considered to contain the entire drawing, which is then extracted as segments 158-1-N, defining a cutting path for excising a piece of the object 101.

The robot acquires colored point clouds obtained from the variable camera frame. The surface containing the drawing is reconstructed by combining the point clouds obtained from multiple views. These clouds are first transformed to the fixed base frame and are then concatenated.

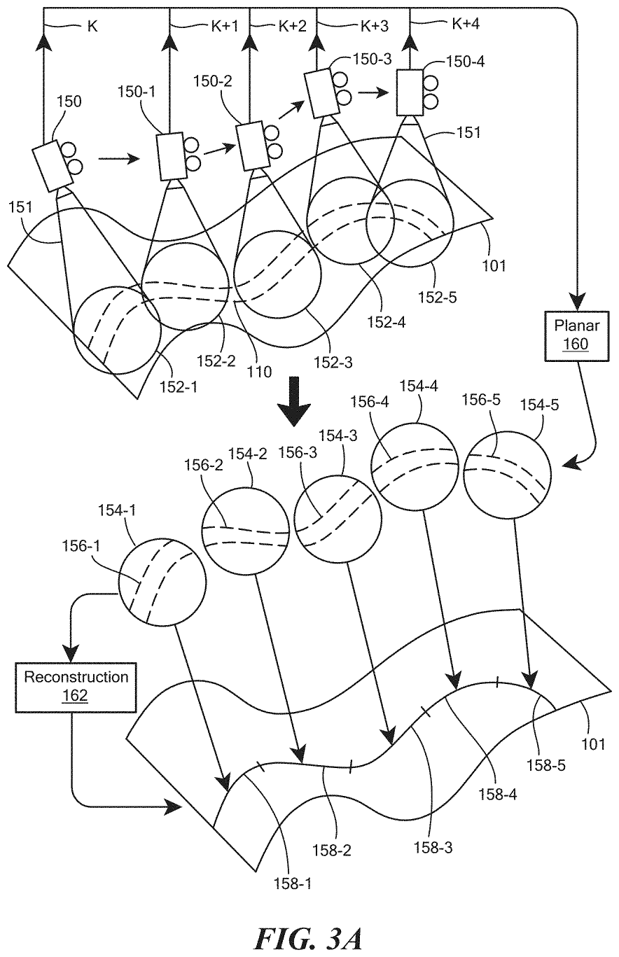

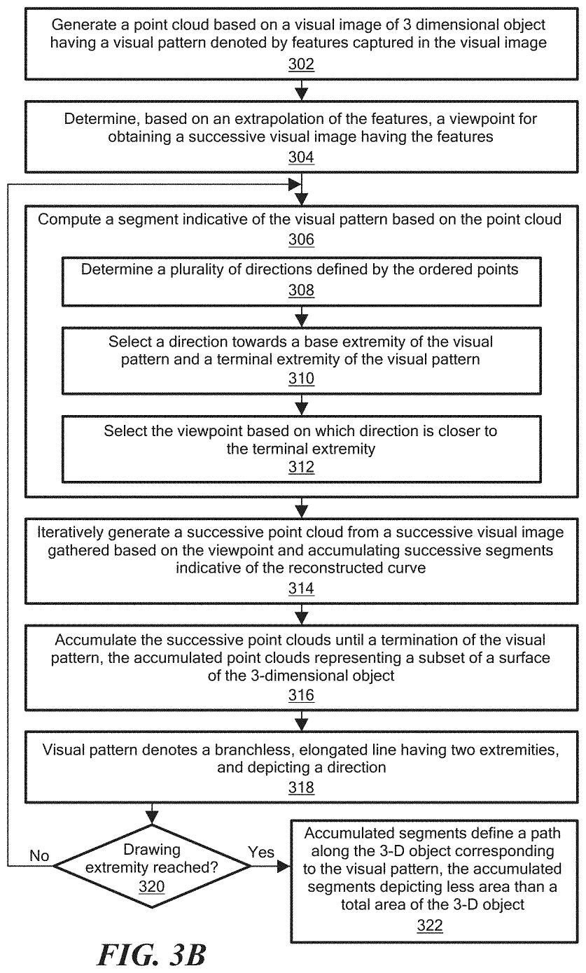

FIG. 3A shows an example of cutting path exploration and execution through feature recognition of a drawing depicted by a painted line (drawing) 110. Referring to FIGS. 1 and 2, the optical sensor 132 is a camera 150, traversing across the object 101 in a series of iterative poses 150′-1 . . . 150′-4 (150′ generally) At each position k of a plurality of iterative positions, the camera 150 captures an image 152-1 . . . 152-5 (152 generally) including the drawing 110. The planner 160 receives each image and generates a point cloud 154-1 . . . 154-5 (154 generally) corresponding to the respective image 152. Each point cloud includes features 156-1 . . . 156-5 (156 generally) detected based on the optical variance (e.g. color) of the drawing 110. From the point clouds, the reconstructor 162 iteratively computes a segment 158-1 . . . 158-5 denoting a sequence of points or voxels in the 3-D space of the object 110 for subsequent traversal by a cutting tool (torch, blade, etc.). Each successive segment 156 is computed based on a viewpoint 151 determined by the features 156 of the previous point cloud 152, without any knowledge of the successive features or the object 101 as a whole.

Active vision systems as incorporated herein investigate the environment to gain pertinent information by manipulating the camera's viewpoint 151. Conventional approaches exhibit shortcomings because they do not exploit the relevant feature information to enhance the NVP. In contrast, configurations herein avoid wasteful scanning of the entire object and target only its desired subsets defined by the drawing along the object 101 surface.

Configurations herein employ probabilistic NBV planners and use formulations. In this approach, a probabilistic volumetric map is used for volumetric scene reconstruction, where the expected information gain is computed from discrete candidate views. We emphasize that the NBV approaches repurpose the aforementioned methods in a specialized framework adapted to the domain-specific task of robotic metal scrap scanning and cutting. This provides performance improvements over conventional approaches which seek to map an entire object or scene and not the subset of the object surface containing the desired feature—thereby solving a distinct problem. In some cases, it may not even be feasible to scan the object entirely due to workspace constraints, dooming conventional approaches to failure.

In the collaborative workflow of FIG. 1, the worker and robot have well-defined roles and functions. From the robot's perspective, the worker provides the cutting references on the object. Afterwards, the robot must discover and recover these references and then carry them out. It should be emphasized that the robot does not know the locations of neither drawing nor object, nor does it assume their shape or size.

It merely assumes their existence, and must autonomously discover and acquire any required properties. This is essential for scrapyard environments, as there is little regularity in shapes, sizes, and cuts. After worker input (rendering the painted line), the robot's tasks are to search to discover an initial partial view of the drawing, and iteratively plan next views to gradually reconstruct the full drawing 110. The reconstructor 162 then generates a 3-D cutting path (segments 156) from this recovered drawing, generates a cutting trajectory within known constraints, and execute the cut and update it with RGB-D feedback. The approach herein provides particular enhancements to recovering the drawing and generating the cutting path via NVP.

More formally, let k≥0 be the exploration's current step. Let ^{c}Cₖ be the cloud obtained at step k with respect to the camera frame c. The camera's pose at step k is ^{b}Tₖ in the base frame b. These acquired clouds ^{c}Cₖ are concatenated to iteratively expand the cumulative knowledge of the drawing.

Accordingly, let ^{b}C_{total,k} be the cloud containing all the RGB-D information obtained thus far, i.e., the cumulative cloud after step k expressed in the base frame. This can be expressed recursively for k≥1 as follows:

$$\{ \begin{matrix}{}^{b} {C}_{total , 0} = {}^{b} {T}_{0} {}^{c} {C}_{0} , \\ {}^{b} {C}_{total , k} = {}^{b} {C}_{total , k - 1} {⋃}^{} {}^{b} {T}_{k} {}^{c} {C}_{k}\end{matrix} \qquad ( 1 )$$

The transformations ^{b}Tₖ map all clouds acquired at different steps k to the base frame for concatenation. The expression bTₖ^{c}Cₖ maps all of the cloud's member points from the camera frame at step k to the base frame.

The loop's next step is to segment the drawing from the current cumulative cloud ^{b}C_{total,k}. Let ϕ_{ξ}(⋅) be the filtering function defined by its parameter ξ which determines its filtering behavior. In our setup, ϕ_{ξ}(⋅) filters by color such that ξ is an admissible range of colors. Let ^{b}D_{total,k} be the cloud representing the drawing such that ϕ_{ξ}: ^{b}C_{total,k}-→^{b}D_{total,k}. With these first four subtasks defined, we summarize their inputs, outputs, and interaction in the pseudocode below.

```
define ProcessClouds(step k) :
    ^{c}Cₖ ← AcquireImageAt(^{b}Tₖ)
    ^{b}Cₖ ← Transform(^{b}Tₖ, ^{c}Cₖ)
    ^{b}C_{total,k} ← Concatenate(^{b}C_{total,k-1}, ^{b}Cₖ)
    ^{b}D_{total,k} ← Filter(ξ, ^{b}C_{total,k})
    return (^{b}D_{total,k}, ^{b}C_{total,k}, ^{b}Cₖ)
```

Until now, we have defined the acquisition and processing of point clouds at a particular viewpoint pose ^{b}Tₖ. The initial viewpoint at k=0 supposedly provided by the mobile search (see FIG. 2) is assumed given. Beyond this, we must obtain the subsequent viewpoints to gradually explore and reconstruct the drawing. For this, we invoke the next view planner 160.

Conceptually, the NVP approach performs higher-level reasoning on the raw point clouds obtained from the ProcessClouds(⋅) procedure. Specifically, the NVP generates candidate viewpoints using information from the cumulative feature cloud ^{b}D_{total,k}, the surface reconstruction ^{b}C_{total,k}, and the latest transformed cloud ^{b}Cₖ. The pseudocode below conceptually sketches the exploration and reconstruction routine.

```
define ReconstructDrawing( ) :
    ^{b}T₀ ← InitialViewpoint( )
    for k = 0,1,...,kₛₜₒₚ − 1:
        (^{b}D_{total,k}, ^{b}C_{total,k}, ^{b}Cₖ) ← ProcessClouds (k)
        ^{b}Tₖ₊₁ ← NextViewpoint(^{b}D_{total,k}, ^{b}C_{total,k}, ^{b}Cₖ)
    ^{b}D_{total,k}_{ₛₜₒₚ} ← ProcessClouds(kₛₜₒₚ)
    return ^{b}D_{total,k}_{ₛₜₒₚ}
```

The loop's stopping condition is determined and checked by the viewpoint planner, terminating the exploration at some eventual step kₛₜₒₚ. After termination, the cumulative cloud ^{b}Ctotal,kstop should contain the entirety of the desired feature. The final and fully reconstructed drawing's point cloud ^{b}Dtotal,kstop is outputted for cutting trajectory generation.

The NextViewpoint(⋅) service can be fulfilled by each of the next view approaches in Tables I-III below. Irrespective of choice, the viewpoint planner controls these two decisions during exploration:
1) Termination: Determine if the drawing is fully explored, and accordingly either proceed searching or terminate.
2) Viewpoint Generation: Provide and select candidate camera poses to continue the robot's search.

For scrap cutting, the NVP approach is subject to performance constraints. An inefficient planner slows down the exploration routine, which would worsen cutting productivity. The planning time is affected jointly by the number of steps and by the step duration. This often comes with a tradeoff, as planners that finish with less steps tend to spend more time per view, and by contrast planners which compute steps rapidly tend to iterate more. This trade-off is presented further below in the approaches of Tables I-III.

The NVP approach determines poses to visit sequentially, throughout the exploration task, to reconstruct the drawing on the object surface. The motion planner attempts to plan a feasible trajectory towards these poses and executes the first viable one. This motion then executes while avoiding collisions.

FIG. 3B is a flowchart of next best view reconstruction based on the drawing of FIGS. 1-3A. After selection of a scrap object 101 and application of a visually distinct drawing, the planner 160 generates a point cloud 154 based on a visual image 152 of the 3-D object 101 having a visual pattern or drawing 110 denoted by features captured in the visual image, as depicted at step 302. The planner 160 determines, based on an extrapolation of the features, a viewpoint for obtaining a successive visual image having the features, as shown at step 304. The features are the color pigmentation of the drawing that differs from the base object 101. Image pixels of the drawing 110 exhibit this feature information. The reconstructor 162 computes a segment 158 indicative of the visual pattern based on the point cloud 152, as depicted at step 306. Using the imaged features 156, the planner 160 determines a plurality of directions defined by the ordered points, at step 308, and selects a direction towards a base extremity of the visual pattern and a terminal extremity of the visual pattern, as depicted at step 310. The drawing 110 is an elongated feature that has a clear dimension along its length, differentiable from the narrower width. This indicates two directions in a given point cloud, one towards the origin, or base, and the other towards the end terminus. The planner 160 selects the viewpoint based on which direction is closer to the terminal extremity, i.e. “facing” the progression towards the end, as opposed to an already traversed region of the object 101, disclosed at step 312.

The planner 160 iteratively generates a successive point cloud 154 from a successive visual image 152 gathered based on the respective viewpoint 151 and accumulating successive segments 158 indicative of the reconstructed curve, as shown at step 314. Successive point clouds 154-(n+1) are accumulated until a termination of the visual pattern, where the accumulated point clouds represent a subset of a surface of the 3-dimensional object 101, as depicted at step 316. In general, the drawing 110 is a visual pattern denoting a branchless, elongated line having two extremities, and depicting a direction, as shown at step 318; there is a clear delineated path by following the line without ambiguous forks or branches.

A check is performed, at step 320, to determine if a drawing extremity has been reached. Typically this means that the point cloud does not indicate an ongoing direction of the drawing, as when the end of the scrap portion for cutting has been attained. As will be discussed further below, an occluded line, as when the drawing wraps a corner or traverses a partially intact member, can be recovered. Iteration for determining successive viewpoints, point clouds and segments otherwise continues. Upon completion, the accumulated segments define a path along the 3-D object corresponding to the visual pattern (drawing 110), such that the accumulated segments 158 depict less area than a total area of the 3-D object, as depicted at step 322.

Aggregating the accumulated segments defines a path along the 3-D object corresponding to the visual pattern that can be pursued by a cutting torch or other robotic actuator. Efficiency is assured since the accumulated segments depict less area than a total area of the 3-D object, as only the drawing, and not the entire 3-D object, needed to be considered.

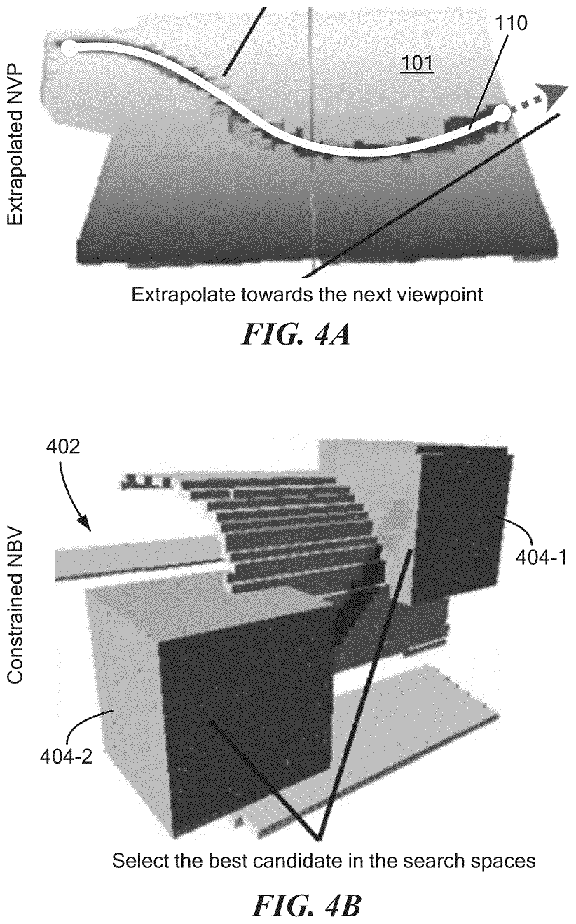

FIGS. 4A-4C show alternate approaches to drawing reconstruction through next best view approaches described herein. In FIGS. 4A-4C, feature-driven NVP approaches including extrapolation, constrained NBV, and a guided NBV approach are described. Each NBV approach:
Obtains point clouds 154 of the object that is marked with the cutting path.
Segments the points that belong to the cutting path.
Processes the object point cloud and the cutting path point cloud to calculate the next viewpoint.
Moves the robot to the next viewpoint 151, and repeats this process until a termination condition is reached.

The approaches are generally distinguished by performance tradeoffs in speed and robustness at finding an occluded portion/segment. FIG. 4A generalizes the procedure for point cloud fitting and curve extrapolation. In contrast to conventional approaches, FIG. 4A reconstructs an unknown drawing on an unknown surface, given a known feature (here, the color red). As such, this process is used as a baseline against which the remaining two are compared. The second approach of FIG. 4B relies on a probabilistic occupancy voxel grid and a quality metric (based on information gain) to explore and rank candidate viewpoints, thereby selecting that which maximizes quality. This planner searches the grid in a rather exhaustive manner. In contrast, a third approach in FIG. 4C exploits greedy-like optimizations for faster searching. The search for the next viewpoint is optimized to seek the most likely path of the drawing.

Referring to FIG. 4A, the point cloud 154 includes a set of points, and the planner 160 sorts the set of points in the point cloud, and determines the viewpoint based on the sorted set of points. This planner 160 treats the feature NVP task like a path exploration problem—by iteratively exploring the branches of an unknown path until all endpoints are found. The point clouds are converted to more useful and more structured representations using fitting methods. The next view is obtained by extrapolating those fits.

Exploring along a path requires a sense of its direction. However, the data obtained from the stereocamera, which is then processed in the procedure ProcessClouds(⋅), remains in the format of point clouds. Essentially, this is an unordered list of 3-D colored points where the direction of the drawing cannot be directly inferred. In this form, viewpoint planning on the desired feature is not straightforward. This planner solves this representation problem by mapping the point cloud to a more usable structure. The cloud data is used to construct or fit spatial curves parametrized in 1-D.

This procedure is captured by the map [symbol] _{xyzRGB}^{G}→ [symbol] × [symbol] _{xyz}³ where the input space [symbol] _{xyzRGB}⁶ represents the point cloud. The output space (a curve) can equivalently be rewritten as a rule [symbol] → [symbol] _{xyz}³, which takes a 1-D parameter and returns a 3-D point. The cloud is thus reduced to a curve as follows:

$${\{ {( {}^{b} {p}_{x} , {}^{b} {p}_{y} , {}^{b} {p}_{z} , {p}_{R} , {p}_{G} , {p}_{B} )}_{j} \}}_{j = 1} {↦}^{Fit} {( {}^{b} {q}_{xyz} ( t ) )}_{t} \qquad ( 2 )$$

This 1-D ordering of 3-D points yields a sense of direction along the curve, which provides the planner 160 with a way to determine the next viewpoint 151 to continue exploring the drawing. Since the curve represents one continuous and known portion of the drawing, the drawing's unknown regions come after the endpoint of this curve. This planner assumes that the entire drawing has two extremities, meaning it is branchless. Thus, after the initial viewpoint, there are two scenarios for curve endpoint selection. If the initial viewpoint happened to already contain one extremity of the drawing, then the planner explores in the direction of the second curve endpoint. On the other hand, if the initial view contains an intermediate portion of the drawing, then the planner has two candidate directions to explore. The curve endpoint closest to the camera is chosen to reduce movement time between unexplored endpoints.

With a chosen curve endpoint, the planner extrapolates to the next viewpoint at each step at a configurable distance δ_{distance}. When δ_{distance}=0, the extrapolated endpoint itself becomes the next viewpoint. Exploring one curve endpoint at a time is slower, but plans towards the drawing extremity more conservatively. Alternatively, δ_{distance}>0 places the next viewpoint, beyond the curve endpoint. This speeds up exploration but may cause some overshoot. Accordingly, keeping the extrapolation distance small is preferable.

Extrapolation only determines the position ^{b}dₖ₊₁ of the next viewpoint. To fully provide the next pose ^{b}Tₖ₊₁, the planner must also determine the next orientation ^{b}Rₖ₊₁ of the camera at that position ^{b}dₖ₊₁. The planner sets the orientation to be orthogonal to the surface at the viewpoint position ^{b}dₖ₊₁. This orientation is obtained by estimating the vector normal to the surface surrounding the viewpoint position ^{b}dₖ₊₁. This region is contained in the cumulative cloud ^{b}C_{total,k}. The viewpoint 151 can be selected by determining a normal orientation to the computed segment effectively define a camera 150 orientation by determining the viewpoint for a pose orthogonal to the segment. Orienting the camera orthogonally helps the robot obtain a more accurate capture of the surface and thus avoid leaving gaps in the drawing point cloud during exploration—which would otherwise require backtracking and cost additional time. The orientation about the normal does not affect output significantly, and is relaxed for motion planning.

The planner continues searching by iteratively obtaining new clouds, fitting a curve on the desired feature, and extrapolating towards the next viewpoint. The planner considers a drawing extremity to be found when the size difference between two consecutive reconstructions ^{b}D_{total,k} falls below a threshold δ_{size}. After both extremities are found, the search terminates and returns the reconstruction ^{b}D_{total,k}stop. This iterative extrapolation procedure is outlined in Table I where the result is the feature's reconstruction.

TABLE 1
Extrapolated next view planner (E-NVP)

```
Input : Initial view containing part of the drawing.
Output: ^{b}D_{total,k}_{ₛₜₒₚ}, fully-reconstructed drawing cloud.
Initialize step, extremities found, and viewpoint.
  step k ← 0
  nₑₓₜᵣₑₘᵢₜᵢₑₛ ← 0
  ^{b}T₀ ← InitialViewpoint( )
Explore the drawing until two extremities are found.
while nₑₓₜᵣₑₘᵢₜᵢₑₛ < 2 do
| Acquire, transform, concatenate, and filter clouds.
| (^{b}D_{tototal,k}, ^{b}Cₖ) ← ProcessClouds(k)
| Backtrack to initial view if drawing size unchanged.
| if size(^{b}D_{total,k}) − size(^{b}D_{total,k-1}) ≤ δ_{size} then
| | nₑₓₜᵣₑₘᵢₜᵢₑₛ ← nₑₓₜᵣₑₘᵢₜᵢₑₛ + 1
| | ^{b}Tₖ₊₁ ← InitialViewpoint( )
| else
| | Fit a curve on the cumulative drawing's cloud.
| | Curve ← Fit(^{b}D_{total,k}, FittingMethod)
| | Obtain next view pose from fit's extrapolation.
| | ^{b}dₖ₊₁ ← Extrapolate(Curve, δ_{distance})
| | ^{b}Rₖ₊₁ ← GetNormalVec(^{b}dₖ₊₁, ^{b}C_{total,k})
| |_  ^{b}Tₖ₊₁ ← ^{b}dₖ₊₁, ^{b}Rₖ₊₁)
|_ k ← k + 1
return ^{b}D_{total,k}_{ₛₜₒₚ}
```

The approach of TABLE I and FIG. 4A may be summarized as generating a sequential ordering of the set of points in each respective point cloud, such that the ordering is based on a correspondence of a color depicted by each point in the set of points matching a color of the visual pattern on the 3-D object, and determining a direction defined by the ordered points. The planner 160 then determines a viewpoint corresponding to the determined direction.

Referring to FIG. 4B, a constrained next-view planning approach is depicted, and shown in TABLE II below. This approach restructures the NVP task into a search problem on a voxel grid 402. In brief, this grid is constructed from the point clouds 154 and updated at each measurement. A frontier region is computed to constrain and generate the candidate search space, within which each candidate is scored with a viewpoint quality metric. For each frontier region of the plurality of frontier region, a probability is computed that the successive viewpoint defines the best viewpoint quality. The best candidate is selected as the next view. This repeats until a termination criterion is met.

The approach of FIG. 4B voxelizes the obtained processed clouds into an octree grid of occupancy probabilities. The point cloud 154 includes a depiction of voxels in a 3-dimensional space indicative of a traversal of the visual pattern across a surface of the 3-D object.

The frontier region represents the forward progress of the reconstructed segments towards a distal terminus of the drawing. The planner 160 may generate an octree representation of the point cloud based on the voxels, and determine a plurality of frontier regions defined by voxels indicative of available successive viewpoints. Successive viewpoints are then computed based on a best viewpoint quality from among the plurality of frontier regions.

The grid distinguishes between occupied, unoccupied, and unknown cells based on their occupancy probabilities—respectively more than, less than, and equal to 0.5. A suitable data structure is used for representing an octree structure as a probabilistic voxel occupancy grid. This grid allows efficient storage and querying of cell probabilities.

Let Gₖ be the voxel grid generated at step k. The local scene's cumulative cloud ^{b}C_{total,k} is voxelized to map the currently available knowledge, while the reconstructed drawing's cumulative cloud ^{b}D_{total,k} is used to identify those voxels belonging to the drawing. Since the drawing 110 is the region of interest, we determine its frontier on the grid. Here we define a frontier cell to have at least one unknown neighbor and at least another neighbor belonging to the drawing's region. The frontier at step k is denoted by Fₖ and represents the boundary of current knowledge about the drawing used to determine high-vantage locations for generating viewpoint search spaces. This constrains the search at step k for the next view in search space Sₖ where candidate viewpoints are scored and ranked. The space is constructed by generating regions from geometric primitives (e.g., cubes, spheres) around each frontier cell, and then concatenating them such that Sₖ=f∈F k S(f) where S(⋅) generates a search space primitive for a single cell.

TABLE II
Constrained Next Best View

```
Input : Initial view containing part of the drawing.
Output: ^{b}D_{total,k}_{ₛₜₒₚ}, fully-reconstructed drawing cloud.
Initialize step, stopping condition, and viewpoint.
  step k ← 0
  stop ← False
  ^{b}T₀ ← InitialViewpoint( )
Search the grid until viewpoint quality is exhausted.
while stop ≡ [symbol]  do
| Acquire, transform, concatenate, and filter clouds.
| (^{b}D_{total,k}, ^{b}C_{total,k}) ← ProcessClouds(k)
| Generate octree grid from cumulative clouds.
| [symbol]   ← GenerateGrid(^{b}C_{total,k}, ^{b}D_{total,k})
| Determine and filter the frontier cells in the grid.
| [symbol]   ← GetFrontier ( [symbol] )
| Generate viewpoint search space around frontier.
| [symbol]   ← [symbol] [symbol]
| Obtain next viewpoint with highest quality.
| ^{b}Tₖ₊₁ ← [symbol]   Q (s)
| Evaluate and update the stopping condition.
| stop ← [symbol]   Q (s) < δ_{Q} or card ( [symbol] ) = 0
|_ k ← k + 1
return ^{b}D_{total,k}_{ₛₜₒₚ}
```

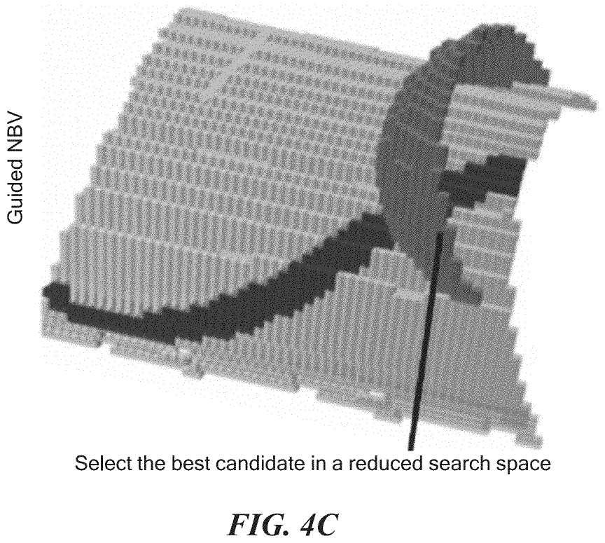

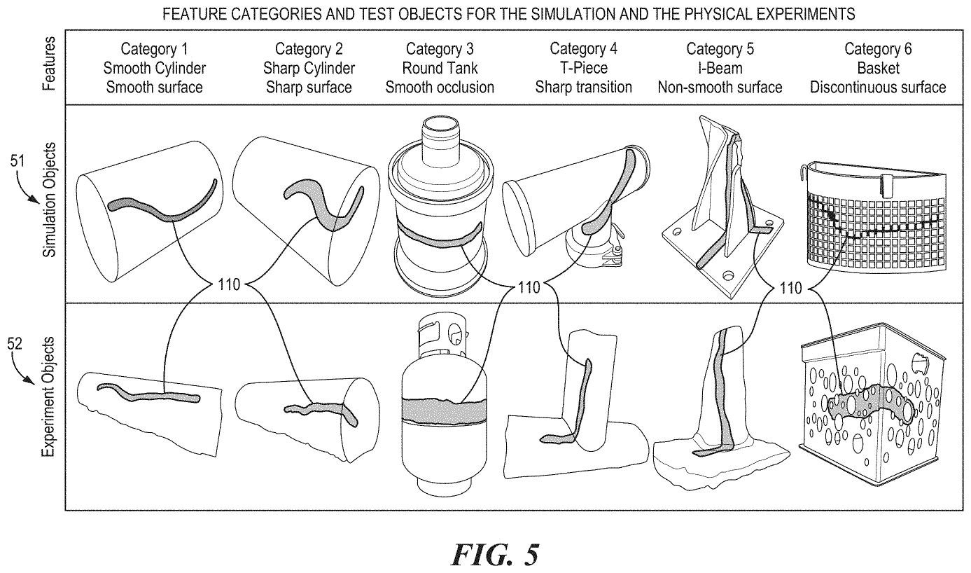

FIG. 5 shows examples of the drawing on differing surface categories of mapped 3-D objects. Referring to FIGS. 1 and 6, test shapes 51 are shown with a corresponding drawing 110, demonstrating variations and occlusions in the object 101. Sample objects 52, portray actual rendering of the drawing 110 on an object for showing how occlusions and surface conditions can affect point cloud information based on the contrasting features in the drawing. In other words, turning corners and surface inconsistencies degrade the quality of the observed features.

FIG. 6 shows camera orientation for directing a pose for a successive viewpoint in drawing reconstruction. Referring to FIG. 6, the camera's viewpoint sₖ can be expressed in the base frame as ^{b}sₖ=(^{b}x, ^{b}y, ^{b}z, αₓ, α_{y}, α_{z}), where (^{b}x, ^{b}y, ^{b}z) is the position in the grid, and (αₓ, α_{y}, α_{z}) is the orientation obtained as anticlockwise rotations about the respective axes. It can also be expressed in the camera frame as:

^{b}Sₖ=^{b}x,^{b}y,^{b}z,αₓ,α_{y},α_{z}),

where

(^{b}x,^{b}y,^{b}z)

is the position in the grid, and (αₓ, α_{y}, α_{z}) is the orientation obtained as anticlockwise rotations about the respective axes. It can also be expressed in the camera frame as:

^{c}Sₖ=(^{c}x,^{c}y,^{c}z,α_{R},α_{P},α_{Y})

where

(^{c}x,^{c}y,^{c}z)

is the position with respect to the camera's frame, and (α_{R}, α_{P}, α_{Y}) is the orientation specified with respect to the local roll-pitch-yaw frame:

(\hat{R},\hat{P},Ŷ)

about the camera's body. The transformations ^{b}sₖ=^{b}Tₖ ^{c}sₖ relate these expressions.

All candidates in Sₖ are scored using a viewpoint quality metric Q(⋅). The next view is set to the best-scoring candidate:

$${}^{b} {T}_{k + 1} = {argmax}_{s ∈ {S}_{k}} Q ( s ) \qquad ( 3 )$$

The quality of a candidate viewpoint at step k is given by:

$$Q ( {s}_{k} ) = λ \cdot \frac{gain ( {s}_{k} )}{{\sum }_{s ∈ {S}_{k}} gain ( s )} - ( 1 - λ ) \cdot \frac{cost ( {s}_{k} )}{{\sum }_{s ∈ {S}_{k}} cost ( s )} \qquad ( 4 )$$

This is a convex combination of a gain term and a cost term, expressed as a proportion of their search space totals. The parameter λ∈[0, 1) determines, for a particular view-point, the relative weight between its gain and cost terms:

gain(sₖ)/Σ_{s∈S}_{ₖ}gain(s) and cost(sₖ)/Σ_{s∈S}_{ₖ} cost(s)

expressed as fractions of the candidate population totals—that is, the aggregate values for every s∈Sₖ. Here, gain(sₖ) quantifies the relevant information gain obtained from choosing sₖ as the next viewpoint. The function cost (sₖ) offsets this gain and is the Euclidean distance between the current viewpoint and the candidate sₖ. This penalizes the quality of a viewpoint on distance from the current position. Therefore, a smaller value for λ prioritizes the highest-ranking viewpoint candidates which are also near the current position.

Hence, the parameter λ directly affects the distance traveled within a measurement step and thus the exploration time. However, λ does not affect the NBV coverage performance in terms of feature reconstruction. In practice, for highly constrained spaces, it is preferable that the robot explores in short bursts, thus favoring a reduced value for λ. Conversely, for highly spacious conditions, the distance constraints can be relaxed, allowing the robot to move to viewpoints further away, which in turn favors an increased value for k. In our evaluations, the parameter is set to λ=^{1/2} to give equal weight to the gain and cost terms, as the evaluation's focus is to assess the feature reconstruction capability. With that said, the parameter λ can be readjusted to application-specific and case-specific needs, if necessary.

The gain(⋅) function is obtained by summing over the grid,

$$gain ( {s}_{k} ) = {\sum }_{g ∈ {𝒢}_{k}} [ h ( g \vert {s}_{k} ) \cdot {p}_{ϕ} ( g ) \cdot {p}_{v} ( g \vert {s}_{k} ) ] \qquad ( 5 )$$

Here, h(g|sₖ) is the information entropy decrease which measures absolute information gain at a cell g after placing the next viewpoint at sₖ. The feature probability p_{ϕ}(g) estimates the feature membership of the cell g, i.e., the chances of belonging to the drawing. The visibility probability pᵥ (g|sₖ) estimates the chance that the cell g is visible from sₖ. The probabilities p_{ϕ}(g) and pᵥ (g|sₖ) respectively penalize distance from the desired feature (the drawing) and occlusion.

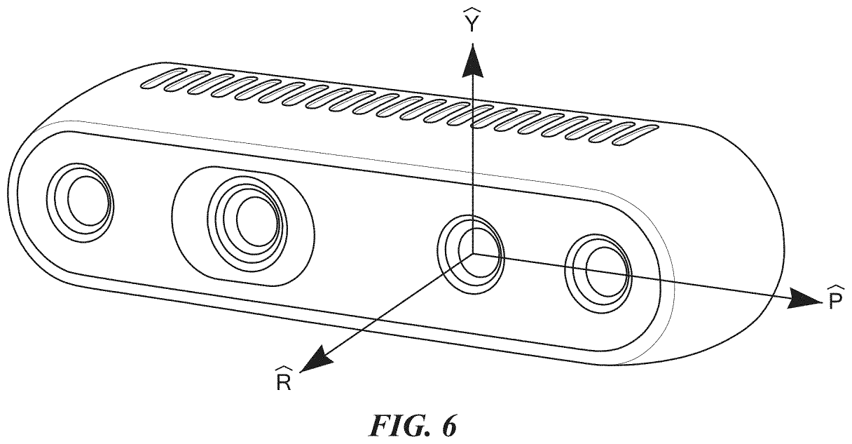

Referring to FIG. 7, the absolute information gained (about the occupancy state at a cell g 180 by moving from the viewpoint sₖ₋₁ to the viewpoint sₖ corresponds to the decrease in information entropy about its occupancy state.

The entropy decrease h(g|sₖ) is obtained through the entropy function He) used in information theory, as follows:

h(g|sₖ)=H(o_{g}|sₖ₋₁)−H(o_{g}|sₖ) (6)

The binary occupancy random variable o_{g} models whether the cell g is unoccupied (o_{g}=0) or occupied (o_{g}=1). The information entropy H(o_{g}|sₖ) quantifies the uncertainty of the binary random variable o_{g} denoting the occupancy of cell g. When this information entropy decreases across two consecutive measurements, i.e., when h(g|sₖ)>0, then we have “lost some uncertainty” or “gained information” about the occupancy state of the grid cell g, after the k^{th} measurement from cell sₖ.

The feature probability is modeled with exponential decay:

p_{ϕ}(g)= [symbol] [ϕ_{g}=1]=exp[−α_{ϕ}dis [symbol] _{ₖ}(g)²] (7)

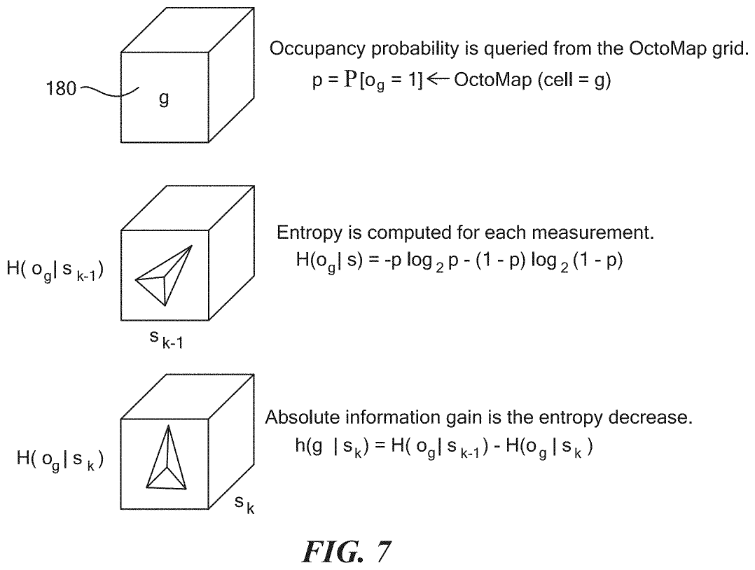

The feature indicator random variable ϕ_{g} models whether the cell g belongs to the drawing (ϕ_{g}=1) or otherwise (ϕ_{g}=0). The function dist _{F} k (⋅) returns the shortest Euclidean distance from g to the nearest frontier cell in Fₖ. The parameter α_{ϕ}>0 is used to tune the exponential decay profile. Maximizing only the absolute information gain between two consecutive viewpoints would lead to seeking novel information about the state of the grid regardless of its relevance to the desired feature. Therefore, new information gained about each cell must also be scaled by the cell's probability of belonging to the desired feature. Referring to FIGS. 8, the feature probability approximates the probability that a grid cell g 182 belongs to the desired feature. The frontier cells in this case represent the cells that have been determined to be part of the desired feature. This feature probability p_{ϕ} is approximated using the assumption that cells near the desired feature have a higher probability of belonging to the feature. This assumption is modeled using an exponential decay profile applied onto the distance to the nearest frontier cell.

The visibility probability at cell g from candidate sₖ is:

$${p}_{v} ( g \vert {s}_{k} ) = ℙ [ {v}_{g , {s}_{k}} = 1 ] = {\prod }_{r ∈ {ℛ}_{k}} ℙ [ {o}_{r} = 0 ] \qquad ( 8 )$$

The binary visibility random variable v_{g,s}k models whether the cell g is visible (v_{g,s}k=1) or otherwise (v_{g,s}k=0) from the candidate sₖ. An unobstructed view to the cell g from a candidate sₖ must be must preferred. Raycasting is performed from sₖ to g, where R ₖ contains all cells traversed by the ray. The probabilities that the ray cells are unoccluded P[oᵣ=0] are multiplied to yield pᵥ (g|sₖ), i.e., the probability that the cell g is visible from the candidate viewpoint Sₖ.

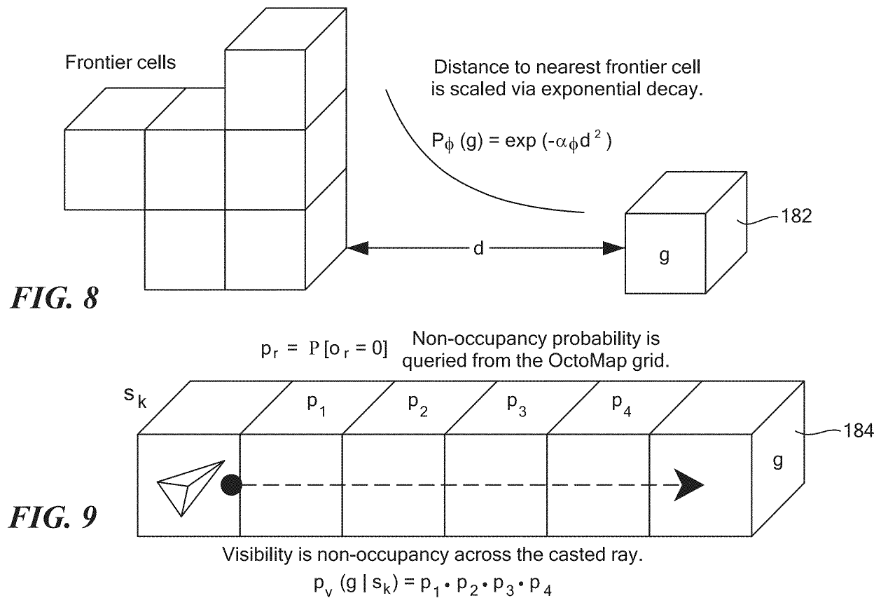

FIG. 9 shows occupancy probability of intermediate cells as representing part of the feature drawing. Referring to FIGS. 7-10, the visibility probability of a cell g 184 from the candidate viewpoint sₖ is computed as the probability pv that all their intermediate cells are occupied.

During the search, all grid positions (^{b}x, ^{b}y, ^{b}z) within Sₖ are attempted for scoring. For each candidate position, the orientation is searched by varying the angles α_{P} and α_{Y}. The C-NB V planner relaxes the angle α_{R} to not overly constrain the motion planner, since the normal direction about the lens has a comparably lesser effect on the information gain in the acquired image. After determining the next viewpoint s*, the camera's grid position (x,y,z) and orientation α_{P} and α_{Y} are set accordingly. The angle α_{R} is determined by the motion planner, and the camera is moved to its new pose.

With the quality metric Q(⋅) fully defined, a next viewpoint can be obtained, and the procedure elaborated above repeats until the following stop condition is met:

[max_{s∈S}_{ₖ}Q(s)<δ_{Q}]∨[card( [symbol] ₖ)=0] (9)

That is, the routine stops once the optimal viewpoint quality falls below a certain threshold δ_{Q}, or when the number of frontier cells reaches zero, whichever condition is met first. This procedure is outlined in TABLE II. The approach of TABLE II presents features to reformulate these approaches. We modify the frontier definition to focus on the desired feature. We also generate constrained search spaces around specific frontier cells to vastly decrease the search's time and memory costs. To determine the NBV's orientation, we constrain its range by pointing the camera at the frontier cells.

A further enhancement to next view planning is a Guided Next Best View (G-NBV) approach, shown in TABLE III and FIG. 4C. This planner implements specialized modifications to radically increase performance. It does this by not only constraining the search, but also explicitly guiding it along the feature. The planner thus uses feature information to perform greedy optimizations.

Unlike the E-NVP planner of TABLE II, the approach of TABLE III does not assume that it explores a path. However, by guiding its search along the feature, it retains the performance advantages of path exploration. Yet, its probabilistic NBV formulation is more robust against unknown space, occlusions, and adversarial geometries. In a sense, this carries the performance advantages of the path exploration paradigm and the robustness characteristics of the probabilistic NBV formulation.

This approach repeats the formulation of the C-NBV approach until after the frontier Fₖ is determined. Despite the large performance improvements of the already reduced frontier, the search space can still become being quite large. Consider the scenario of a large object with a drawing traversing long parts of its surface. This produces a long frontier with little overlap between the individual search spaces S(⋅), causing the concatenated search space Sₖ to significantly grow.

To address this, the G-NBV planner reduces the frontier Fₖ into a single frontier cell f\hat{ }k. A plurality of frontier regions may be clustered into a number of frontier clusters less than the number of the plurality of frontier regions. The successive viewpoint is selected based on the frontier cluster corresponding to the least distance from the viewpoint. For this, the frontier cells are clustered using a suitable voxel clustering method. We use a connectedness-based clustering method, whereby any neighboring frontier cells are lumped into the same cluster. Now, the frontier is composed of several clusters, of which the nearest one (to the current pose) is chosen. The centroid f\hat{ }k of this nearest cluster is computed and then used as the single-voxel frontier for generating the search space.

TABLE III
Guided Next Best View (G-NBV) approach

| Input : Initial view containing part of the drawing. | |
|---|---|
| Output: ^{b}D_{total,k}_{ₛₜₒₚ}, fully-reconstructed drawing cloud. | |
| Initialize step, stopping condition, and viewpoint. | |
| step k ← 0 | |
| stop ← False | |
| ^{b}T₀ ← InitialViewpoint( ) | |
| Search the grid until viewpoint quality is exhausted. | |
| while stop ≡ False do | |
| \| | Acquire, transform, concatenate, and filter clouds. |
| \| | (^{b}D_{total,k}, ^{b}C_{total,k}) ← ProcessClouds(k) |
| \| | Generate octree grid from cumulative clouds. |
| \| | [symbol] ← GenerateGrid(^{b}C_{total,k}, ^{b}D_{total,k}) |
| \| | Determine and filter the frontier cells in the grid. |
| \| | [symbol] ← GetFrontier( [symbol] ) |
| \| | Reduce the frontier set into a single frontier cell. |
| \| | [symbol] ← GetClusters( [symbol] , ClusteringMethod) |
| \| | [symbol] ← GetNearestCluster( [symbol] ) |
| \| | \hat{f}ₖ ← GetClusterCentroid( [symbol] ) |
| \| | Generate viewpoint search space around centroid. |
| \| | [symbol] ← S(\hat{f}ₖ) |
| \| | Obtain next viewpoint with orientation constraint. |
| \| | ${}^{b} {T}_{k + 1} ← {argmax}_{s ∈ {𝒮}_{k}} Q ( s ) s . t . {}^{b} {R}_{k + 1} = Rot ( s , {f}_{k} )$ |
| \| | Evaluate and update the stopping condition. |
| \| | stop ← [symbol] Q (s) < δ_{Q} or card( [symbol] ) = 0 |
| \|_ | k ← k + 1 |

return ^{b}D_{total,k}_{ₛₜₒₚ}

This offers numerous performance advantages. First, by trimming the other clusters, the planner explores any number of branches, one at a time, avoiding long and exhaustive searches. Second, since there is only one frontier cell, then the entire search space consists of a single geometric primitive around the cell, e.g., a sphere around the centroid. This is a reasonable step, as frontier cells tend to surround the current reconstructed drawing's endpoints. Thus, searching around this centroid would implicitly guide the planner along the drawing. A third advantage lies in determining orientations for the candidate viewpoints. This is normally expensive as it drastically increases the search space, since for every position there are several the camera orientations. We eliminate this problem entirely by constraining the orientation from the candidate cell s to the frontier centroid f\hat{ }k, thus predetermining the values for the angles αP and αY. This reduces G-NBV's search to only the grid positions, since αP and αY are predetermined and aR is delegated to the motion planner. The search space is thus not only reduced cell-wise, i.e., attempt only the search space around f\hat{ }k rather than around the entire frontier, but also pose-wise, i.e., search only grid positions in the search space while constraining the camera orientation.

This constraint is justified due to the localized information on the drawing. In effect, high viewpoint qualities concentrate in the unknown space around the current reconstructed drawing's endpoints. Fixing the orientation towards the centroid eliminates the exploration of alternatives where the gain is often marginal or negative. By exploiting the drawing's structure, the planner is able to rapidly select the next viewpoint.

By using any of the three aforementioned approaches, we obtain the fully-reconstructed cloud of the drawing. This cloud is used to generate a suitable cutting path from the generated segments (along the drawing) that can be used as a reference for cutting control. We accomplish this task of converting unstructured point clouds to ordered paths, as in the mapping (2), by using suitable curve fitting methods. This is the same class of methods used in the Extrapolated NVP's curve fitting step. In effect, any of the corresponding approaches of TABLES I-III are is suitable for obtaining a cutting path from the fully-reconstructed drawing.

Those skilled in the art should readily appreciate that the programs and methods defined herein are deliverable to a user processing and rendering device in many forms, including but not limited to a) information permanently stored on non-writeable storage media such as ROM devices, b) information alterably stored on writeable non-transitory storage media such as solid state drives (SSDs) and media, flash drives, floppy disks, magnetic tapes, CDs, RAM devices, and other magnetic and optical media, or c) information conveyed to a computer through communication media, as in an electronic network such as the Internet or telephone modem lines. The operations and methods may be implemented in a software executable object or as a set of encoded instructions for execution by a processor responsive to the instructions, including virtual machines and hypervisor controlled execution environments. Alternatively, the operations and methods disclosed herein may be embodied in whole or in part using hardware components, such as Application Specific Integrated Circuits (ASICs), Field Programmable Gate Arrays (FPGAs), state machines, controllers or other hardware components or devices, or a combination of hardware, software, and firmware components.

While the system and methods defined herein have been particularly shown and described with references to embodiments thereof, it will be understood by those skilled in the art that various changes in form and details may be made therein without departing from the scope of the invention encompassed by the appended claims.

What is claimed is:

1. A method for reconstructing a curve on a 3-dimensional object, comprising:
generating a point cloud based on a visual image of 3-dimensional object having a visual pattern denoted by features captured in the visual image;
determining, based on an extrapolation of the features, a viewpoint for obtaining a successive visual image having the features;
computing a segment indicative of the visual pattern based on the point cloud; and
iteratively generating a successive point cloud from a successive visual image gathered based on the viewpoint and accumulating successive segments indicative of the reconstructed curve.

2. The method of claim 1 wherein the point cloud includes a set of points, further comprising:
sorting the set of points in the point cloud; and
determining the viewpoint based on the sorted set of points.

3. The method of claim 1 further comprising accumulating the successive point clouds until a termination of the visual pattern, the accumulated point clouds representing a subset of a surface of the 3-dimensional object.

4. The method of claim 1 wherein the visual pattern denotes a branchless, elongated line having two extremities, and depicting a direction.

5. The method of claim 1 wherein the point cloud includes a depiction of voxels in a 3-dimensional space indicative of a traversal of the visual pattern across a surface of the 3-D object.

6. The method of claim 1 further comprising:
generating a sequential ordering of the set of points in each respective point cloud; the ordering based on a correspondence of a color depicted by each point in the set of points matching a color of the visual pattern on the 3-D object;
determining a direction defined by the ordered points; and
determining a viewpoint corresponding to the determined direction.

7. The method of claim 2 further comprising
determining a plurality of directions defined by the ordered points;
selecting a direction towards a base extremity of the visual pattern and a terminal extremity of the visual pattern; and
selecting the viewpoint based on which direction is closer to the terminal extremity.

8. The method of claim 1 further comprising:
determining a normal orientation to the computed segment; and
determining the viewpoint for a pose orthogonal to the segment.

9. The method of claim 1 further comprising:
generating an octree representation of the point cloud based on voxels;
determining a plurality of frontier regions defined by voxels indicative of available successive viewpoints; and
computing the successive viewpoints based on a best viewpoint quality from among the plurality of frontier regions.

10. The method of claim 9 further comprising, for each frontier region of the plurality of frontier regions, computing a probability that the successive viewpoint defines the best viewpoint quality.

11. The method of claim 9 further comprising:
clustering the plurality of fr6ntier regions into a number of frontier clusters less than the number of the plurality of frontier regions; and
selecting the successive viewpoint based on the frontier cluster corresponding to the least distance from the viewpoint.

12. The method of claim 1 further comprising aggregating the accumulated segments for defining a path along the 3-D object corresponding to the visual pattern, the accumulated segments depicting less area than a total area of the 3-D object.

13. A method of directing a cutting head along a scrap item, comprising:
traversing a prescribed path based on non-exhaustive analysis of a local area of features along the prescribed path;
evaluating a successive cutting position based on a likelihood of a direction that the prescribed path proceeds in; and
iteratively traversing the prescribed path based on a probabilistic determination of cells defining a search space including the prescribed path.

14. The method of claim 13 further comprising identifying the prescribed path based on an optical surface characteristic; the prescribed path defining a cutting operation directed towards a target object.

15. The method of claim 13 wherein the prescribed path is defined by contrasting optical features and recognition of the optical features.

16. The method of claim 15 wherein the optical features are defined by a surface applied pigmentation.

17. The method of claim 13 wherein evaluating further comprises:
generating a probabilistic occupancy grid indicative of a search space in the local area; and
scoring each cell in the grid based on a probability of path progression.

18. The method of claim 17 wherein generating the probabilistic occupancy grid further comprises gathering a sampling of surface features and corresponding cutting patterns, the cutting position evaluated based on the surface features and the likelihood of the direction computed based on the cutting patterns.

19. The method of claim 13 further comprising:
forming the prescribed path by marking a line on the scrap item having varied optical features;
scanning the features based on an optical recognition to define a 3-dimensional (3-D) recognition of the prescribed path; and
directing a cutting apparatus based on the 3-D recognition.

20. A computer program embodying program code on a non-transitory computer readable storage medium that, when executed by a processor, performs steps for reconstructing a curve on a 3-dimensional (3-D) object, the method comprising:
generating a point cloud based on a visual image of the 3-D object having a visual pattern denoted by features captured in the visual image;
determining, based on an extrapolation of the features, a viewpoint for obtaining a successive visual image having the features;
computing a segment indicative of the visual pattern based on the point cloud; and
iteratively generating a successive point cloud from a successive visual image gathered based on the viewpoint and accumulating successive segments indicative of the reconstructed curve.
